(19) United States
(12) Patent Application Publication
(10) Pub. No.: US 2025/0229228 A1
(43) Pub. Date: Jul. 17, 2025

(54) ELECTROCHEMICAL DIRECT AIR CAPTURE OF CO2 USING REDOX-ACTIVE TEXTILES

(71) Applicants: THE REGENTS OF THE UNIVERSITY OF MICHIGAN, Ann Arbor, MI (US); University of Massachusetts, Boston, MA (US)

(72) Inventors: David Kwabi, Ann Arbor, MI (US); Trisha Andrew, Hadley, MA (US)

(21) Appl. No.: 18/700,414

(22) PCT Filed: Oct. 12, 2022
(86) PCT No.: PCT/US2022/046370

§ 371 Date: Apr. 11, 2024

Related U.S. Application Data
(60) Provisional application No. 63/262,433, filed on Oct. 12, 2021.

(51) Int. Cl. B01D 53/96; B01D 53/62; B01D 53/78

(52) U.S. Cl. CPC B01D 53/965; B01D 53/62; B01D 53/78; B01D 2257/504

(57) ABSTRACT

A system and process for CO₂ capture and release can include an electrochemical de-acidification of a pH varying electrolyte cause by reduction of PCET active molecules in a flow cells to produce a pH varying electrolyte capable of CO₂, followed by acidification of the pH varying electrolyte caused by oxidation of the PCET active molecules to release the captured CO₂.

### STATEMENT OF GOVERNMENT SUPPORT

The invention was made with government support under DE-AR0001413 awarded by the U.S. Department of Energy. The government has certain rights in the invention.

### BACKGROUND

### Field of the Disclosure

The disclosure relates to systems and methods for the electrochemical capture and release of CO₂ and more particularly to direct air capture of CO₂ using proton-coupled electron transfer molecules and release of the captured CO₂.

### Brief Description of Related Technology

The most common electrochemical technique for CO₂ separation involves capture via nucleophilic binding between it and the reduced version of a redox couple, followed by CO₂ release when the reduced species is oxidized. This technique relies on the use of a molecular redox couple whose Lewis affinity for CO₂ is much higher in the reduced than oxidized form. The net electrical work input per mole of CO₂ separated is the difference between the work required to reduce the couple and the work returned from oxidizing the reduced, CO₂-bound species. Several types of redox couples have been considered, including those based on quinones, bipyridinic molecules, transition meta complexes and thiolates. Where the binding constant of CO₂ to the reduced redox couple is large, CO₂ capture from oxygen-free gas compositions with low CO₂ concentrations is possible. Scovazzo et al, demonstrated using a 2,6-di-tertbutyl-1,4-benzoquinone-based redox pair, the electrochemical pumping of CO₂ from an inlet stream comprising about 0.5% to an exit of 85.3 kPa. This performance was facilitated by the large binding constant between the reduced quinone and CO₂ (>106 L/mol), which lead to a record low electrical work input requirement of up to 100 KJ/mol_{CO2}. These performance metrics, however, are completely lost in the presence of molecular oxygen. The redox potentials of most chemically stable redox couples are lower than the O₂ reduction potential. Thus, during direct air capture (DAC), oxidation of the reduced redox couples by oxygen in air occurs rather than CO₂ capture. Where the redox couples are dissolved in organic solvents, an additional limitation is the high vapor pressure of the solvent, which results in significant loss of material during direct are capture.

An alternative approach to electrochemical CO₂ capture is to harness Brønsted acid/base equilibria and use the OH⁻ and H⁺ ions generated during electrolytic water dissociation for reactive CO₂ capture and release, respectively. Eisaman et al have reported the electric work input required for CO₂ separation with this method, where water dissociation occurs across a biopolar membrane (electrodialysis). The system achieved an acceptable direct air capture rate at a capture solution of pH >13 and the electrical work input for capture solution regeneration varied from 1062 KJ/mol_{CO2} at an applied current density of 10 mA/cm² to 4235 KJ/mol_{CO2} at 100 mA/cm². These energy inputs are exorbitantly high, making this an unfeasible system. The high energy inputs result from water dissociation reactions which necessary involve Faradaic water reduction/oxidation reactions at the system's terminal electrodes, which are notorious for large kinetic losses. Further, at high OH concentrations, significant OH transport across the membrane occurs before reaction with CO₂ leading to OH recombination with H+rather than CO₂ and thus parasitic efficiency losses.

### SUMMARY

A system for electrochemical direct air capture of CO₂ in accordance with the disclosure can include a CO₂ source from which CO₂ is to be captured; a flow cell comprising a separator that divides the flow cell into a counter electrolyte chamber and a pH-varying electrolyte chamber, a counter electrode disposed in the counter electrolyte chamber, and a working electrode disposed in the pH-varying electrolyte chamber. The working electrode includes a substrate having a coating of the proton-coupled electron transfer molecules immobilized thereon, the substrate being a conductive substrate or comprising a conductive layer. The flow cell also includes a counter electrolyte tank in fluid communication with the flow cell and configured such that counter electrolyte is capable of being circulated through the counter electrolyte tank and the counter electrolyte chamber of the flow cell. Alternatively, a water-stable, charging storing solid electrode can be used in place of the counter electrode and the counter electrolyte. The flow cell also includes a pH-varying electrolyte tank in fluid communication with the flow cell and the CO₂ source; and a flash tank in fluid communication with the pH-varying electrolyte tank and optionally the flow cell.

The system can include a first flow path configured to allow a flow of the pH-varying electrolyte to circulate through the pH-varying electrolyte tank and the pH-varying electrolyte chamber of the flow cell, wherein during a charging cycle of the flow cell, flow through the first flow path results in an increase in pH of the pH-varying electrolyte caused by reduction of the proton-coupled electron transfer molecules, and during a discharging cycle of the flow cell, flow through the first flow path results in a decrease in pH of the pH varying electrolyte by oxidation of the proton-coupled electron transfer molecules.

The system can include a second flow path configured to allow a flow of the pH-varying electrolyte to circulate through the pH-varying electrolyte tank and the CO₂ source, wherein the system is adapted to direct the pH-varying electrolyte through the second flow path after the pH of the pH-varying electrolyte is increased to thereby allow for sorption of CO₂ by the pH varying electrolyte from the CO₂ source during circulation through the second flow path.

The system also includes a third flow path configured to circulate a flow of the pH-varying electrolyte either (i) through the pH-varying electrolyte tank and the flash tank, or (ii) from the pH-varying electrolyte chamber to the flash tank, from the flash tank to the pH-varying electrolyte tank. The system is adapted to direct flow through the third flow path after the pH of the pH-varying electrolyte is reduced by the discharge cycle to thereby release the sorbed CO₂. The acidification process in the discharge cycle can include circulating flow through the first flow path until the desired pH is achieved and then directing the pH-varying electrolyte from the pH-varying electrolyte tank to the flash tank on the third flow path. Alternatively, the discharge cycle can include a portion of flow through the first flow path-that is flow from the pH-varying electrolyte tank to the pH-varying electrolyte chamber for acidification, followed by flow on the third flow path from the pH-varying electrolyte chamber to the flash tank.

A process for the direct air capture of CO₂ in accordance with the disclosure can include electrochemical de-acidification of a pH-varying electrolyte using a flow cell charging cycle, which includes circulating the pH-varying electrolyte from a pH-varying electrolyte tank through a pH-varying electrolyte chamber of a flow cell. The pH-varying electrolyte chamber includes a working electrode comprising a substrate having proton-coupled electron transfer molecules immobilized thereon, the substrate being a conductive substrate or comprising a conductive layer. The flow cell further includes a counter electrode chamber having a counter electrode and a membrane separating the pH-varying chamber and the counter electrode chamber. The counter electrolyte is circulated through the counter electrode chamber during the charging and discharging cycles. Alternatively, a water-stable, charge-storing solid electrode can be used in place of the counter electrode and the counter electrolyte. During circulation of the pH-varying electrolyte through the pH-varying electrolyte chamber, the proton-coupled electron transfer molecules are reduced thereby increasing of the pH-varying electrolyte to a CO₂ capture pH forming an alkaline pH-varying electrolyte. The process further includes a CO₂ capture step in which the alkaline pH-varying electrolyte is circulated in contact with a CO₂ source, wherein the alkaline pH-varying electrolyte sorbs CO₂ from the CO₂ source. The process then includes electrochemical acidification of the alkaline pH-varying electrolyte with sorbed CO₂ using a flow cell discharging cycle, which includes circulating the alkaline pH-varying electrolyte with sorbed CO₂ through the pH-varying electrolyte chamber. During discharge, the proton-coupled electron transfer molecules are oxidized thereby lowering the pH of the alkaline pH-varying electrolyte to a CO₂ release pH to form an acidified pH-varying electrolyte, the CO₂ release pH being less than the CO₂ capture pH. The process then includes degassing the acidified pH-varying electrolyte to release the sorbed CO₂.

### BRIEF DESCRIPTION OF THE DRAWINGS

FIGS. 1A and 1B are schematic illustrations of systems of the disclosure;

FIG. 2 is a schematic illustration of a system and process of the disclosure;

FIGS. 3A-3B are graphs showing ex situ characterization of PAAQ films deposited onto a planar polyethylene terephthalate substrate by (A) UV-vis spectroscopy, (B) LDI-MS, and (C) ATR FT-IR;

FIG. 4 is a schematic illustration of a tubular shaped RVD hot-wall reactor used to synthesize PEDOT;

FIG. 5 is a schematic illustration of a tubular shaped RVD hot-wall reactor used to synthesis PCET-active polymers;

FIGS. 6A and 6B are graphs showing pH swing behavior of (A) PAAQ-coated and (B) bare PEDOT electrodes;

FIG. 7 shows chemical structures and frontier orbital densities for monomers for forming PCET polymer coatings;

FIG. 8 is a schematic illustration of an experimental set-up for pH swing experiments;

FIGS. 9A-9C are photographs showing (A) a redox flow cell setup; (B) the redox-flow cell after assembly; and (C) a system in accordance with the disclosure using the redox-flow cell of FIG. 9B;

FIG. 10 is a graph showing five cycles of CO₂ capture (decrease in pCO₂) and release (increase in pCO₂) effected by pH swing created from PCET. Cell voltage, electrolyte pH, and CO₂ concentration in operando were monitored;

FIG. 11 is a graph showing the number of moles of electrode-bound species vs areal loading for an electrode of volume 1 cm³ and specific areas of 100 cm²/cm³ and 1000 cm²/cm³;

FIG. 12 is a schematic illustration of PCET reactions of anthraquinones and phenazine;

FIG. 13 is a schematic illustration of simplified structures of anthraquinone- and phenazine-based monomers for polymerization; and

FIG. 14 is a graph showing the ration of electrolyte volume to electrode area to swing to pH 13.

### DETAILED DESCRIPTION

Proton-coupled electron transfer (PCET) plays key roles in photosynthesis, biological respiration, and in the operation of several types of inorganic energy conversion and storage devices, such as water electrolyzers and aqueous organic flow batteries. In the flow cells of the disclosure, high concentrations of PCET-active redox couples assembled near the electrode surface with a strongly alkaline solution is created upon bulk reduction and used for direct air capture. Systems of the disclosure using PCET to create alkalinity for CO₂ capture can beneficially suppress OH crossover, and thus, the energy losses from OH⁻H⁺ recombination. Systems of the disclosure can have low energetic costs by using kinetically-facile redox couples, and compatibility with direct air capture that electrochemically-influenced Brønsted acid/base equilibria affords.

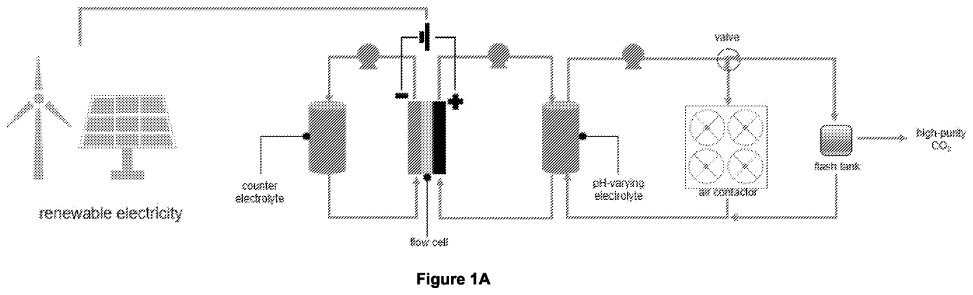

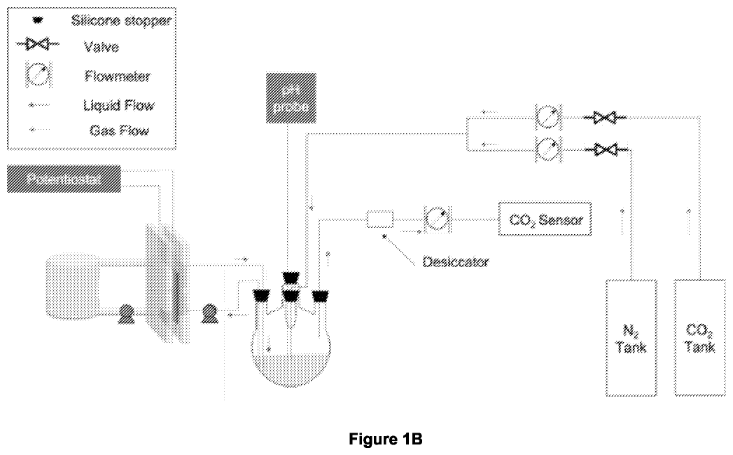

Referring to FIG. 1, a system for electrochemical direct air capture of CO₂ from CO₂ containing source can include a flow cell having a counter electrode separated from a PCET-active electrode by a membrane. A chamber for flow of electrolyte is defined on each side of the membrane. Each chamber is in fluid communication with an electrolyte tank for circulation of the electrolyte through the flow cell chamber and back into the tank. In some arrangements, the counter electrode and counter electrolyte pairing and associated electrolyte tank can be replaced by a water-stable, charge-storing solid electrode, just as MnO₂, carbon titanium phosphate, or any other such solid electrode known in the art.

The working electrode of the flow cell includes a substrate that is conductive or has a conductive layer disposed therein. The substrate further includes a coating comprising PCET molecules immobilized thereon. The electrolyte flowed on the working electrode side of the flow cell is an unbuffered pH-varying electrolyte. The tank containing the pH-varying electrolyte is in fluid communication with the electrolyte chamber on the working side of the flow cell (referred to herein as the pH-varying electrolyte chamber) and the CO₂ source. The system further includes a flash tank that is in fluid communication with the pH-varying electrolyte tank and optionally the flow cell.

The system includes a first flow path configured to allow a flow of the pH-varying electrolyte to circulate through the pH-varying electrolyte tank and the pH-varying electrolyte chamber of the flow cell. The flow through the first flow path during charging results in an increase in pH of the pH-varying electrolyte caused by reduction of the proton-coupled electron transfer molecules. During a discharging cycle of the flow cell, the pH-varying electrolyte is also flowed through the first path or through a third flow path that includes flow through the pH-varying electrolyte chamber. The flow through the first flow path during discharging results in a decrease in pH of the pH varying electrolyte caused by oxidation of the proton-coupled electron transfer molecules.

The system further includes a second flow path configured to allow a flow of the pH-varying electrolyte to circulate through the pH-varying electrolyte tank and the CO₂ source. The system is adapted to direct the pH-varying electrolyte through the second flow path after the pH of the pH-varying electrolyte is increased to thereby allow for sorption of CO₂ by the pH varying electrolyte from the CO₂ source during circulation through the second flow path.

The system also includes a third flow path configured to circulate a flow of the pH-varying electrolyte either (i) through the pH-varying electrolyte tank and the flash tank, or (ii) from the pH-varying electrolyte chamber to the flash tank, from the flash tank to the pH-varying electrolyte tank. In arrangements in which third flow path circulates the pH-varying electrolyte through the pH-varying electrolyte tank and the flash tank, the discharging cycle can be performed by flowing and circulating the pH-varying electrolyte through the first flow path. In arrangements in which the third flow path circulate the pH-varying electrolyte from the pH-varying electrolyte chamber to the flash tank, the discharge cycle include flowing the pH-varying electrolyte along a portion of the first path from the pH-varying electrolyte tank to the pH-varying electrolyte chamber where the pH is decreased and then flowing from the pH-varying electrolyte chamber to the flash tank along the third flow path for CO₂ release. The pH-varying electrolyte can then be flowed back to the pH-varying electrolyte tanks. The system is adapted to direct flow through either arrangements of the third flow path after the pH of the pH-varying electrolyte is reduced by the discharge cycle to thereby release the sorbed CO₂.

A method for capture and release of CO₂ from a CO₂ source includes an electrochemical de-acidification of the pH-varying electrolyte. This is performed using a charging cycle of the flow cell while flowing the pH-varying electrolyte through the first flow path. The pH-varying electrolyte pH is increased during the charging cycle by the reduction of the proton-coupled electron transfer molecules. The electrochemical de-acidification is performed until the pH-varying electrolyte reaches a suitable pH for CO₂ capture (referred to herein as the CO₂ capture pH). The electrochemical de-acidification can cause the pH-varying electrolyte to become alkaline or substantially alkaline. For example, the pH after electrochemical de-acidification can be up to pH 14. For example, the pH can be in a range of about 9 to about 14, about 9 to about 13, about 10 to about 13. The pH after de-acidification can be, for example, about 9, 10, 11, 12, 13, or 14, any values or ranges there-between.

After the pH-varying electrolyte is at the CO₂ capture pH, a CO₂ capture step is performed. During CO₂ capture, the pH-varying electrolyte is flowed through the second flow path and circulated through the CO₂ source where it will come in contact with and sorb CO_{2 from} the CO₂ source. Repeated circulation through the CO₂ source can be utilized to reach a desired saturation of CO₂ in the pH-varying electrolyte.

Once the pH-varying electrolyte has reached the desired saturation level of sorbed CO₂, an electrochemical acidification can be performed. The pH-varying electrolyte having the sorbed CO₂ can be flowed through the pH-varying electrolyte chamber, while performing a discharge cycle. While the pH-varying electrolyte is flowing through the pH-varying electrolyte chamber during discharge, the pH of the pH-varying electrolyte is decreased by the oxidation of the proton-coupled transfer molecules to form an acidified pH-varying electrolyte having a CO₂ release pH less than the CO₂ capture pH. The CO₂ release pH can be neutral or substantially neutral. For example, the CO₂ release pH can be about 4 to about 6. Other suitable CoO₂ release pH ca include about 4, 5, and 6, and any values or ranges there-between. The drop in pH allows the CO₂ to be released from the pH-varying electrolyte. The pH-varying electrolyte with the CO₂ release pH is flow either directly from the pH-varying electrolyte chamber to a flash tank or from the pH-varying electrolyte tank to the flash tank, where the CO₂ is released from the pH-varying electrolyte and collected. The acidification process in the discharge cycle can include circulating flow through the first flow path until the desired pH is achieved and then directing the pH-varying electrolyte from the pH-varying electrolyte tank to the flash tank on the third flow path. Alternatively, the discharge cycle can include a portion of flow through the first flow path that is flow from the pH-varying electrolyte tank to the pH-varying electrolyte chamber for acidification, followed by flow on the third flow path from the pH-varying electrolyte chamber to the flash tank.

The system and process can be performed with a current density of about 0.1 mA/cm² to about 20 mA/cm².

Any unbuffered electrolyte capable of changing pH can be used. The electrolyte can include, for example, a supporting salt, such as KCl. In embodiments, seawater can be used as the pH-varying electrolyte. Shifting the pH of seawater from pH 8 to pH 4-6 can result in release of CO₂ from the seawater.

The system and process can further include use of a CO₂ hydration catalyst. The CO₂ hydration catalyst can be, for example, dissolved in the pH-varying electrolyte. The CO₂ hydration catalyst can be selected from one or more of carbonic anhydrase, zinc triazacycles, zinc tetraazacycles, copper glycinates, hydroxopentaaminecobalt perchlorate, formaldehyde hydrate, saccharose, phenols, phenolates, glycerin, arsenite, hypochlorite, hypobromite and oxyanionic species.

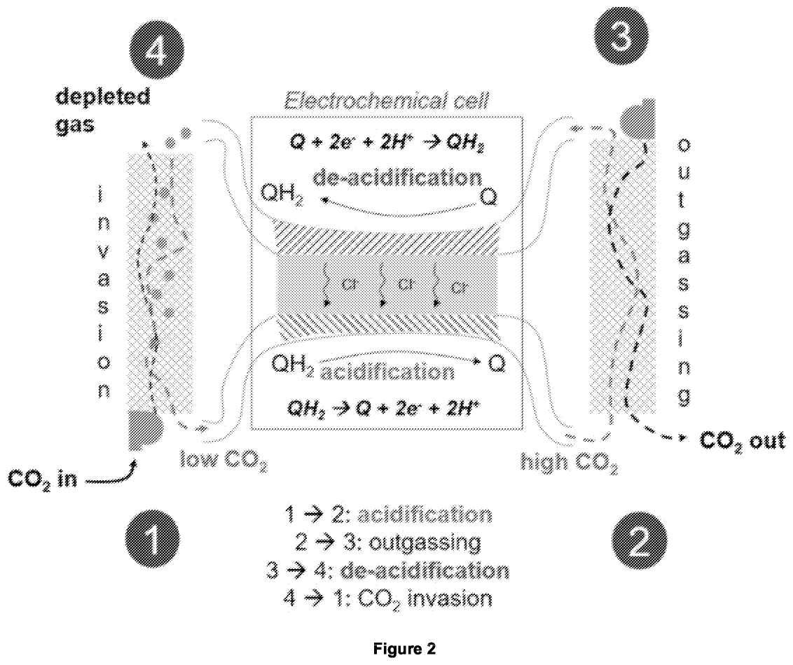

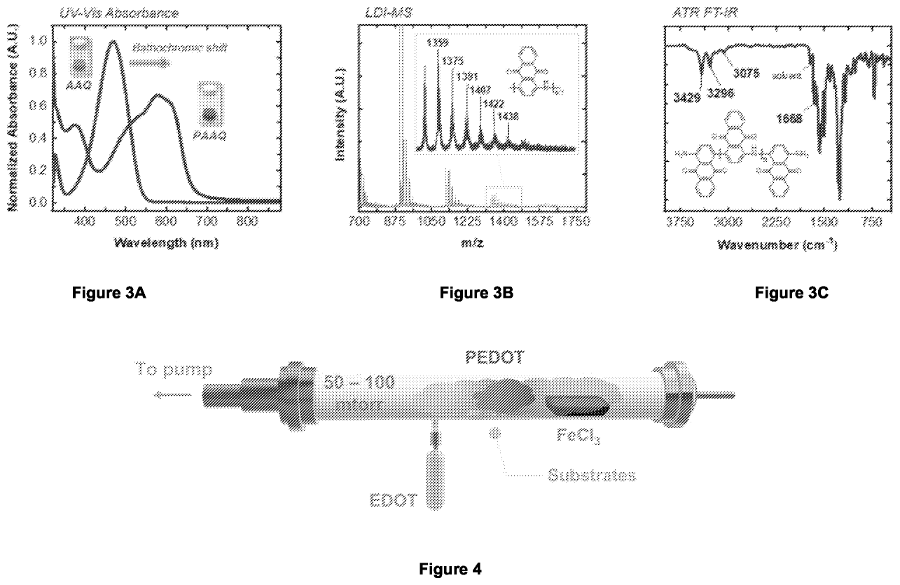

Referring to FIG. 2, a schematic illustration for a process of CO₂ capture and release is shown. A series of alternating electrochemical PCET and gas-liquid exchange processes occur. In FIG. 1, Q/QH₂ (Q+2e⁻+2H⁺→QH₂) represents a hypothetical electrode surface-bound redox couple. In the process, electrochemical oxidation of QH₂ and acidification of unbuffered electrolyte with high carbonate concentration occurs between 1 and 2 shown in FIG. 3. Outgassing of supersaturated CO₂ at the exit stream until gas-liquid equilibrium is reached occurs between 2 and 3 shown in FIG. 1. Electrochemical reduction of Q and de-acidification of the electrolyte resulting in a strongly alkaline electrolyte occurs between 3 and 4 shown in FIG. 1. Finally, reactive absorption of CO₂ from air into the alkaline electrolyte at an inlet occurs between 4 and 1. Charge balancing of the PCET reactions can be achieved by crossover of spectator ions rather than OH⁻ and H⁺ through an anion-exchange membrane. The spectator ion can be Cl for example and can be introduced into the supporting electrolyte.

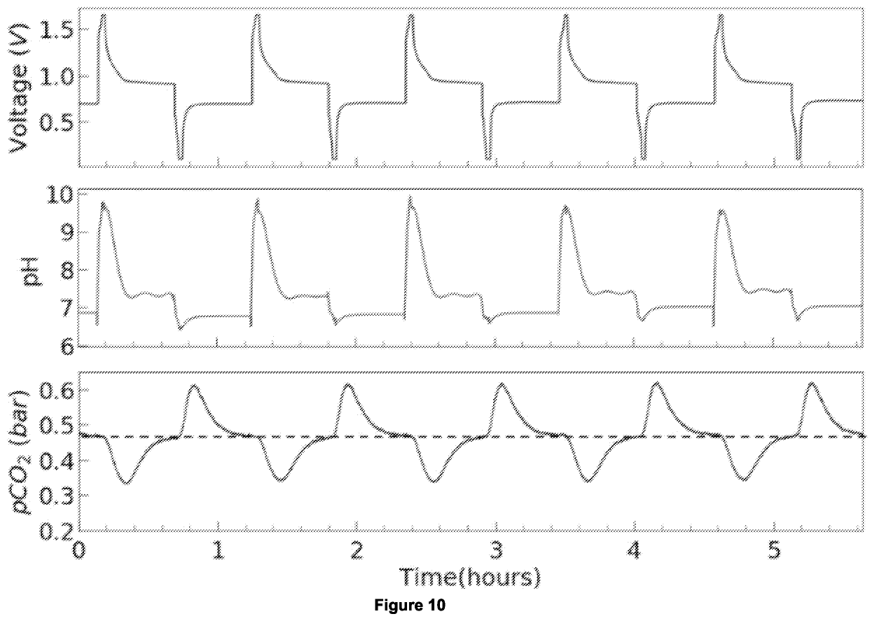

The minimum electrical work input required to run the cycle shown in FIG. 2 was calculated from the difference in electric potential during acidification versus de-acidification. It was found to be less than 100 KJ/mol_{CO2}. This minimum work can decrease if the PCET and gas-liquid exchange occurs simultaneously, in a two-process cycle. For example, a four-process cycle with an exit/inlet CO₂ partial pressure ratio of 10 has a minimum work input of 50 KJ/mol_{CO2}. In the two process version, this input drops to 5.7 KJ/mol_{CO2}, which is the same as the thermodynamic minimum work required for separation across a pressure ration of 10. A two-process cycle was tested by constructing an aqueous flow cell containing 0.1M of phenazine-based PCET-active couple and KCL supporting electrolyte. The bulk electrolytic redox reactions in the presence of about 0.47bar CO₂ gas resulted in CO₂ absorption and release with approximately 100% efficiency as shown in FIG. 10. At 40 mA/cm², the total work consumed was 60 KJ/mol_{CO2}, which is comparable to some of the lowest work inputs reported for previously non-direct air capture compatible CO₂ separation methods. It is estimated from considering energy losses necessary to account for the observed CO₂ capture and release that a system of the disclosure can have a minimum work input as low as 8 KJ/mol_{CO2}.

The CO₂ source be a direct air source or other sources containing CO₂, such as flue gas or other industrial waste gas sources or emissions, air, and seawater. Any chamber, vessel, reservoir, or the like which can receive an input of the CO₂ source and a flow of the electrolyte can be used.

In the systems and methods of the disclosure, the working electrode can be either the positive or the negative electrode.

The system can further include an external power source for charging the flow cell. The external power source can be any power source known in the art. For example, a solar and/or wind power source could be used.

The pH-varying electrolyte can experience a pH swing of about pH 14 to about pH 6, or about pH 13 to about pH 6, or about pH 10 to about pH 7 during charging and discharging of the flow cell. Other suitable pH swing values between 14 and 6 can be used herein so long as the CO₂ capture pH is a higher pH than the CO₂ release pH.

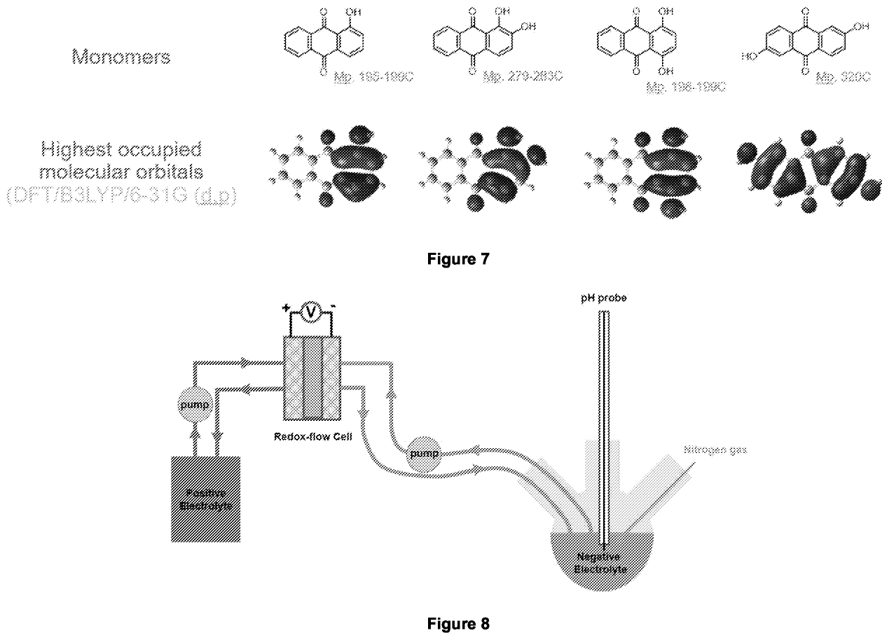

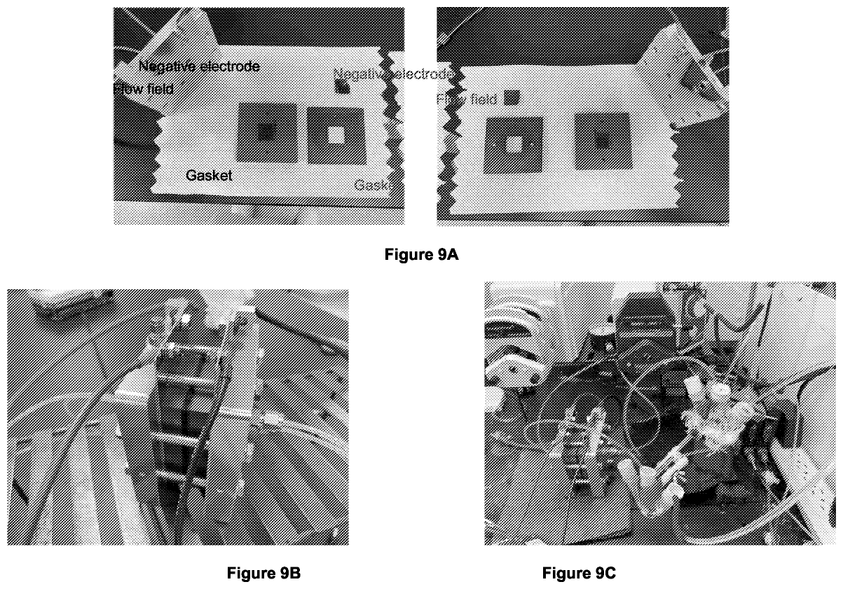

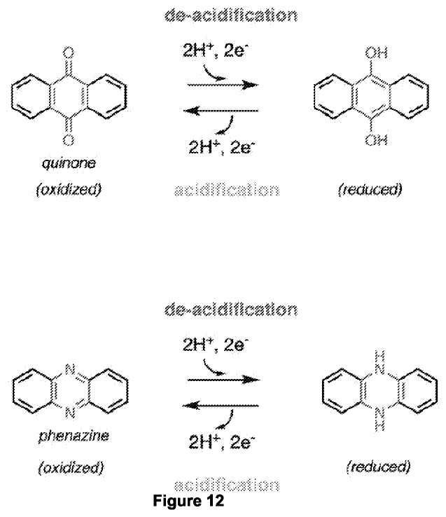

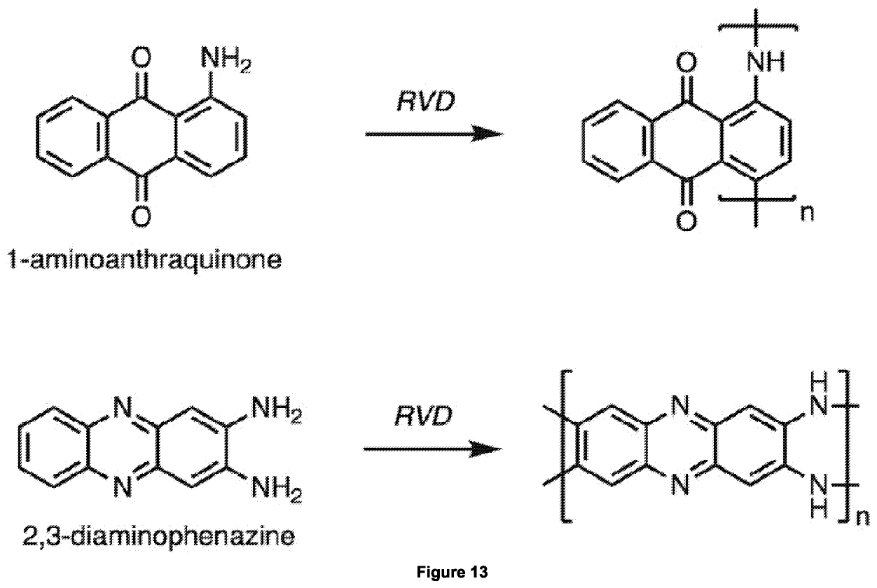

The coating comprising the proton-coupled electron transfer molecules can be a polymer coating. The polymer can be formed of one or more monomers selected from sulfonated anthraquinone, hydroxyl-substituted sulfonated anthraquinone, 1-aminoanthraquinone, 2-aminoanthraquinone, Alizarin, Quinizarin, 1-pyrrolo-anthraquinone, 2-pyrrolo-anthraquinone, 2,3-diaminophenazine, carboxyl-substitute phenazine. FIG. 7 illustrates chemical structures and frontal orbital densities of monomers that can be used for forming PCET-active coatings. FIG. 12 illustrates the structures of two monomers, quinone and phenazine in the oxidized and reduced states. The polymers resulting from these monomers can be 1-aminoantrhaquinone and 2,3 diaminophenazine, respectively. FIG. 13 illustrates simplified structures of the monomers for polymerization.

The working electrode can include a non-conducting material as the substrate, upon which a conducting layer is formed. Alternatively, the substrate can be a conducting material. In either option, the substrate can be or can include a textile. For example, nylons, felts, and/or cottons can be used. For example, the textile can be one or more of woven cotton fabrics, graphite felt, tobacco cotton, cotton gauze, cotton muslin, wool felt, synthetic felt, nylon, and nylon/cotton blends. The substrate can be, for example, any porous, permeable material. In embodiments, the substrate can be an insulating material. The substrate can be, for example, a composite of PEDOT and a PCET-active material.

In embodiments in which the working electrode comprises a conductive layer, poly(3,4-ethylenedioxythiophene) (PEDOT) can be used for the conductive layer. For example, the working electrode can include PEDOT or other conductive layer disposed on a substrate and interposed between the substrate and the coating containing PCET molecules. The PCET molecules can be immobilized on the substrate through attachment to the conductive layer in such arrangements.

In any of the embodiments herein, the working electrode can have a coating of PCET molecules on both sides of the working electrode. For example, the substrate can be coated with a conductive layer on opposed sides and a coating of PCET molecules can be formed on each of the opposed sides.

The reduced form of many known PCET-active redox couples are thermodynamically susceptible to oxidation in air, when freely dissolved in a capture solution. The air oxidation side reaction will act as a parasitic process that reduces overall electrical efficiency of acidification/de-acidification and can contribute to eventual electrode fatigue. Immobilization of PCET-active molecules can be used to minimize diffusion-limited air oxidation side reactions. Immobilization of PCET-active molecules on electrode surfaces can allow for any air-oxidized byproducts to be re-reduced by the electric field at the electrode surface and, thus, continue participating in the acidification/de-acidification process without contributing to electrode fatigue. Immobilization can also facilitate preventing mobile side products from poisoning the capture solution over operation times.

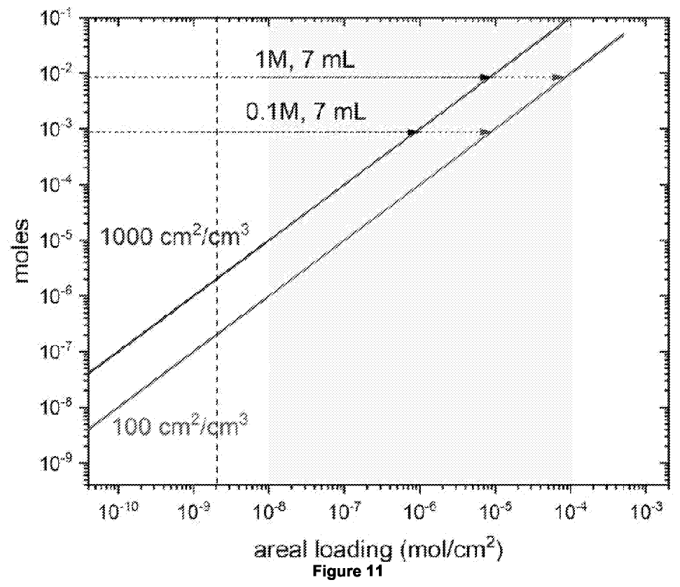

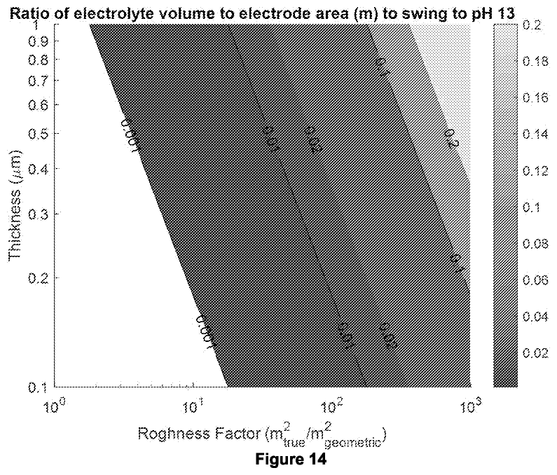

FIG. 11 is a graph showing the relationship between the number of moles of a small molecule bound to the electrode and the required loading per true area of the electrode in moles/cm². This assumes a macroscopic electrode volume of 1 cm³ and thickness of 3 mm. This relationship is shown as a function of specific area of the electrode, defined as a ratio of the internal pore area to the electrode volume, in cm²/cm³. The dashed vertical line in FIG. 11 is at 12×10⁻¹⁰ mol/cm², which is the maximum estimated loading for a close packed monolayer of phenyl rings on a planar surface. The dashed horizontal lines in FIG. 11 correspond to the number of moles of redox species contained in solutions of 7 ml and 0.1 M and another solution of 1 M. The area in grey shows the range of loadings achievable if thick films between 100 nm and 100 microns of PCET-active molecules are formed on the substrate, assuming a molecular concentration within the film of 0.001 mol/cm³. FIG. 14 shows the ratio of electrolyte volume to electrode area to swing to pH 13, assuming starting pH of 4 and a concentration of redox-active units within the film of 10⁻⁴ mol/cm³ for 2H⁺, 2e⁻ transfer.

The coating of PCET molecules can have a thickness of about 100 nm to about 10 microns, about 1 micron to about 10 microns, about 500 nm to about 1 micron, about 5 microns to about 10 microns. Other suitable thicknesses include about 100 nm, 200 nm, 300 nm, 400 nm, 500 nm, 600 nm, 700 nm, 800 nm, 900 nm, 1 micron, 2 microns, 3 microns, 4 microns, 5 microns, 6 microns, 7 microns, 8 microns, 9 microns, 10 microns, and any values there-between or ranges formed by any of such values.

Polymer-coated PCET-active textile electrodes can be formed, for example, using reactive vapor deposition (RVD). Polymerization of the monomer in RVD proceeds in situ via its oxidation in the vapor phase. In the presence of a substrate, this process simultaneously and conformally coats the substrate with a polymer film. It has been observed that the resulting conjugated polymer is mechanically and chemically robust, and it thickness can be controlled by adjusting the duration of the deposition and temperature of the reaction zone. The porosity of the film can be modified by regulating the relative fluxes of both monomer and oxidant within the reactor. Conductive, PCET-active electrodes can be formed by RVD using insulating textile substrates, for example, by first depositing a conductive polymer coating (the conductive layer) followed by a second deposition to create the PCET-active coating. Various monomers can be used in forming the PCET-active coating using RVD. For example, 1-aminoantrhaquinone (1-AAQ) was used. FIGS. 3A-3C shows the results of ex situ characterization of PAAQ films using UV-vis spectroscopy, laser desorption/ionization-mass spectrometry (LDI-MS) and attenuated total reflection Fourier transform infrared (ATR FT-IR) spectroscopy. US-vis measurements showed a main peak that is red-shifted from that of 1-AAQ owing to conjugation of the latter in the polymer. LDI-MS showed fragmentation patterns consistent with the formation of conjugated units of 1=AAQ. ATR FT-IR measurements displayed a peak at 1668 cm⁻¹, which is the position expected for the ketone group in 1-AAQ, indicating is preservation in PAAQ.

The PCET-active coating can be porous. Without intending to be bound by theory, it is believed that although porous coatings may have reduced loadings of PCET-active molecules, the improved solvent/electrolyte accessibility and mass transport features of the porous coatings may lead to enhanced acidification/de-acidification of the pH-varying electrolyte.

The flow rate of the pH varying electrolyte can be adjusted to achieve a desired rate of CO₂ capture. The flow rate can be adjusted to control the residence time of the pH-varying electrolyte with the CO₂ source. A flow rate of about 10 ml/min to about 100 ml/min can be used and can be adjusted throughout the process when the electrolyte is in different flow paths to tune the conditions of the system. In embodiments, the flow rate of the counter electrolyte can be reduced or stopped entirely during CO₂ capture if CO₂ capture is occurring separately from CO₂ de-acidification.

In any of the arrangements herein, multiple flow cells and/or tanks with individual flow paths as described herein can be utilized for continuous operations of the various steps with different pH-varying electrolyte portions.

Flow cells and process of the disclosure can enable electrochemical direct air capture of CO₂ with work inputs less than or equal to 100 KJ/mol_{CO2}.

### Examples

### Synthesis of poly(3,4-ethylenedioxythiophene) (PEDOT) by Reactive Vapor Deposition (RVD)

A tubular shaped, hot-wall deposition system as depicted in FIG. 4 was used in the reactive vapor depositions herein. 5 mL of 3,4-ethylenedioxythiophene (EDOT) was added to a glass ampule. The ampule was then attached to the monomer inlet of the deposition system using a needle-valve with two glass-to-metal fittings. An excess of iron (III) chloride (FeCl₃) was added to a ceramic crucible. The crucible was loaded into the deposition system and placed in-line with the monomer inlet. Substrates (graphite felt) were positioned between the monomer inlet and the crucible containing FeCl₃. The deposition system was pumped down to a pressure between 50-100 mtorr using an Edwards Direct-Drive vacuum pump. The substrates, oxidant, and monomer were then heated to temperatures of 110° C., 190° C., and 85° C., respectively, using resistive heating tapes. After 20-30 minutes, or the time required for FeCl₃ vapor to fill the headspace above the substrates, the needle-valve was opened to flow monomer vapor into the deposition system and begin the oxidative polymerization reaction. The reaction continued for 20-30 minutes, at which point the needle-valve was manually closed to stop the monomer vapor from flowing. The substrates coated with PEDOT films were removed from the deposition system and submerged in an aqueous 0.5 M sulfuric acid solution for 10-30 minutes, or the time required to remove any residual monomers and metal salts.

### Synthesis of PCET-Active Polymers by Reactive Vapor Deposition

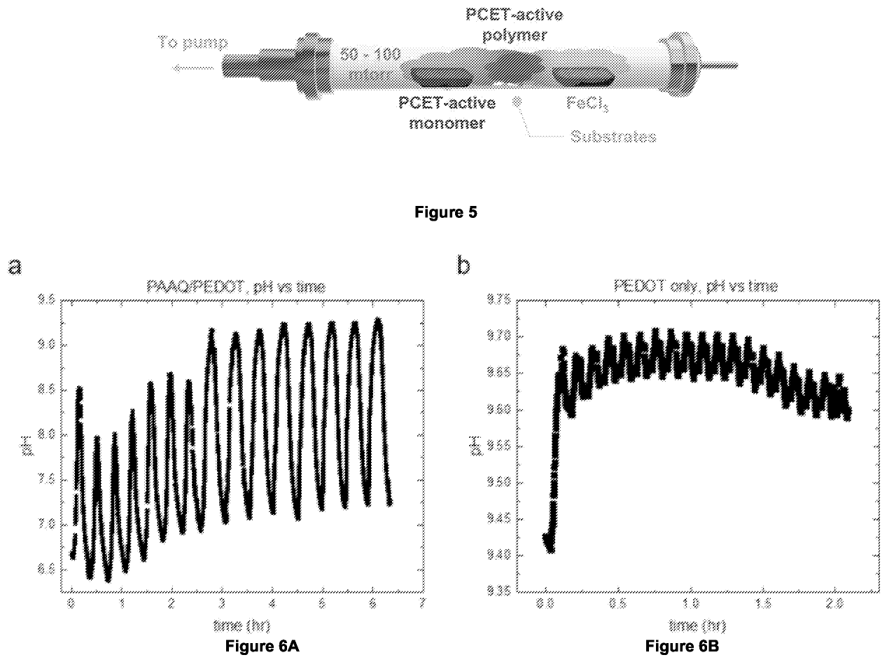

A tubular shaped, hot-wall deposition system without a monomer inlet was used, as shown in FIG. 5. The PCET active monomers used are outlined in table 1.

TABLE 1
Parameters for the synthesis of PCET-active polymers.

| | Monomer | | Deposition |
|---|---|---|---|
| | temp. | Gap time | time |
| PCET-active monomer | (Tₘₒₙ, ° C.) | (t_{gap}, min) | (t_{dep}, min) |
| 1-aminoanthraquinone | 163 | 1 | 9 |
| 2-aminoanthraquinone | 170 | 1 | 9 |
| Alizarin | 200 | 1 | 13 |
| Quinizarin | 160 | 2 | 15 |
| 1-pyrrolo-anthraquinone | 170 | 1 | 10 |
| 2-pyrrolo-anthraquinone | 190 | 1 | 10 |

10 mg of a PCET-active monomer was weighed and added to a tungsten crucible. An excess of iron (III) chloride (FeCl₃) was then added to a ceramic crucible. The crucibles containing the PCET-active monomer and FeCl₃ were consecutively loaded into the deposition system (monomer before oxidant) and placed in-line with one another. Substrates (graphite-felt) were placed inside the deposition system adjacent to the crucible containing the PCET-active monomer. The deposition system was subsequently pumped down to a pressure between 50-100 mtorr using an Edwards Direct-Drive vacuum pump. The crucible containing FeCl₃ was then heated to 195° C. using a resistive heating tape. Some time (t_{gap}) later, the crucible containing the PCET-active monomer was heated to a temperature, Tₘₒₙ using a resistive heating tape. The deposition system was left undisturbed for a time (t_{dep}), at which point the heating tapes were removed from the deposition system. The substrates coated with PCET-active polymer were then removed from the deposition system and submerged in methanol for 10-30 minutes, or the time required to remove any residual monomers and metal salts.

### pH Swing Measurements

The pH swing created by poly (aminoanthraquinone) (PAAQ) films deposited onto carbon cloth and poly(3,4-ethylenedioxythiophene) (PEDOT)-coated cotton substrate was measured. The electrodes were integrated into aqueous flow cells with an unbuffered electrolyte with KCl as a supporting salt, a cation-exchange membrane, and a counter electrolyte containing the ferri-ferocyanide redox couple at excess capacity. The carbon cloth electrodes exhibited significant pH swing behavior whether or not the PAAQ coating was present. It is believed that the pH swing in this case originated from water splitting reactions catalyzed by trace Fe-related impurities adsorbed on the carbon cloth. In contrast, the PAAQ-coated PEDOT electrode enabled several cycles of reversible pH swing between neutral pH (about 7.2) and slightly alkaline (pH 9.3) conditions over the course of several hours, whereas the pH swing for the uncoated PEDOT electrode was small (about 0.05 pH units). FIGS. 6A and 6B illustrates the pH swing behavior of PAAQ-coated and bare PEDOT electrodes. It was estimated that the areal quinone loading was about 10⁻⁸ mol_{AAQ}/cm², considering the pH swing realized by the PAAQ/PEDOT electrode, its 5 cm² geometry surface area, and assuming each AAQ unit in the polymer participates in 2H⁺, 2e⁻ PCET. This estimate was in agreement with an independent estimate of 9.6×10⁻⁷ mol_{AAQ}/cm² from capacitance measurements. The resistance of the PAAQ/PEDOT electrode was measured using a two point probe ammeter and was 496 Ω/cm². FIG. 8 shows a schematic illustration of the experimental set-up used for the pH swing experiments.

The foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In the case of conflict, the present description, including definitions, will control.

Throughout the specification, where the compounds, compositions, methods, and/or processes are described as including components, steps, or materials, it is contemplated that the compounds, compositions, methods, and/or processes can also comprise, consist essentially of, or consist of any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

### REFERENCES

1. Carbon Dioxide Market Size, Share & Trends Analysis Report By Source (Ethyl Alcohol, Substitute Natural Gas), By Application (Food & Beverage, Medical), By Region, And Segment Forecasts, 2021-2028; Grand View Research: 2021; pp 1-125.
2. Hanna, R.; Abdulla, A.; Xu, Y.; Victor, D. G., Emergency deployment of direct air capture as a response to the climate crisis. Nature Communications 2021, 12 (1), 368.
3. Holmes, G.; Keith, D. W., An air-liquid contactor for large-scale capture of CO₂ from air. Philos Trans A Math Phys Eng Sci 2012, 370 (1974), 4380-403.

4 Li, Z.; Pan, M. S.; Su, L.; Tsai, P.-C.; Badel, A. F.; Valle, J. M.; Eller, S. L.; Xiang, K.; Brushett, F. R.; Chiang, Y.-M., Air-Breathing Aqueous Sulfur Flow Battery for Ultralow-Cost Long-Duration Electrical Storage. Joule 2017, 1 (2), 306-327.
5. Keith, D. W.; Holmes, G.; St. Angelo, D.; Heidel, K., A Process for Capturing CO2 from the Atmosphere. Joule 2018.
6 Kang, J. S.; Kim, S.; Hatton, T. A., Redox-responsive sorbents and mediators for electrochemically based CO2 capture. Current Opinion in Green and Sustainable Chemistry 2021, 100504.
7. Voskian, S.; Hatton, T. A., Faradaic electro-swing reactive adsorption for CO2 capture. Energy & Environmental Science 2019, 12 (12), 3530-3547.
8. Renfrew, S. E.; Starr, D. E.; Strasser, P., Electrochemical Approaches toward CO2 Capture and Concentration. ACS Catalysis 2020, 10 (21), 13058-13074.
9. Power, I. M.; Harrison, A. L.; Dipple, G. M.; Southam, G., Carbon sequestration via carbonic anhydrase facilitated magnesium carbonate precipitation. International Journal of Greenhouse Gas Control 2013, 16, 145-155.
10. Henderson, M. A.; Keith, D. W.; Pal, A.; Kainth, S.; Heidel, R. K.; Ritchie, J. A. Target Gas Capture 2014.
11. Ji, Y.; Goulet, M.-A.; Pollack, D. A.; Kwabi, D. G.; Jin, S.; De Porcellinis, D.; Kerr, E. F.; Gordon, R. G.; Aziz, M. J., A phosphonate-functionalized quinone redox flow battery at near-neutral pH with record capacity retention rate. Adv. Energy Mater. 2019.
12. Huskinson, B., Marshak, M. P., Suh, C., Er, S., Gerhardt, M. R., Galvin, C. J., Chen, X., Aspuru-Guzik, A., Gordon, R. G., Aziz, M. J., A metal-free organic-inorganic aqueous flow battery. Nature 2014, 505 (7482), 195-8.
13. Lin, K.; Chen, Q.; Gerhardt, M. R.; Tong, L.; Kim, S. B.; Eisenach, L.; Valle, A. W.; Hardee, D.; Gordon, R. G.; Aziz, M. J.; Marshak, M. P., Alkaline quinone flow battery. Science (New York, N.Y.) 2015, 349, 1529-32.
(1) Scovazzo, P.; Poshusta, J.; DuBois, D.; Koval, C.; Noble, R. Electrochemical Separation and Concentration of <1% Carbon Dioxide from Nitrogen. Journal of The Electrochemical Society 2003, 150, D91.
(2) Gurkan, B.; Simeon, F.; Hatton, T. A. Quinone Reduction in Ionic Liquids for Electrochemical CO2 Separation. Sustainable Chemistry and Engineering 2015, 3, 1394-1405.
(3) Mizen, M. B.; Wrighton, M. S. REDUCTIVE ADDITION OF CO2 TO 9,10-PHENANTHRENEQUINONE. Journal of the Electrochemical Society 1989, 136, 941-946.
(4) Apaydin, D. H.; Głowacki, E. D.; Portenkirchner, E.; Sariciftci, N. S. Direct Electrochemical Capture and Release of Carbon Dioxide Using an Industrial Organic Pigment: Quinacridone. Angew. Chem.-Int. Edit. 2014, 53, 6819-6822.
(5) Voskian, S.; Hatton, T. A. Faradaic electro-swing reactive adsorption for CO2 capture. Energy & Environmental Science 2019, 12, 3530-3547.
(6) House, K. Z.; Baclig, A. C.; Ranjan, M.; van Nierop, E. A.; Wilcox, J.; Herzog, H. J. Economic and energetic analysis of capturing CO2 from ambient air. Proc Natl Acad Sci USA 2011, 108, 20428-20433.
(7) Eisaman, M. D.; Alvarado, L.; Larner, D.; Wang, P.; Garg, B.; Littau, K. A. CO2 separation using bipolar membrane electrodialysis. Energy Environ. Sci. 2011, 4, 1319-1328.
(8) Eisaman, M.; Schwartz, D.; Amic, S.; Larner, D.; Zesch, J.; Torres, F.; Littau, K. Technical Proceedings of the 2009 Clean Technology Conference and Trade Show, 2009; p 3-7.
(9) Rheinhardt, J. H.; Singh, P.; Tarakeshwar, P.; Buttry, D. A. Electrochemical Capture and Release of Carbon Dioxide. ACS Energy Letters 2017, 2, 454-461.
(10) Ranjan, R.; Olson, J.; Singh, P.; Lorance, E. D.; Buttry, D. A.; Gould, I. R. Reversible Electrochemical Trapping of Carbon Dioxide Using 4,4′-Bipyridine That Does Not Require Thermal Activation. J. Phys. Chem. Lett. 2015, 6, 4943-4946.
(11) Ishida, H.; Ohba, T.; Yamaguchi, T.; Ohkubo, K. INTERACTION BETWEEN CO2 AND ELECTROCHEMICALLY REDUCED SPECIES OF N-PROPYL-4,4′-BIPYRIDINIUM CATION. Chemistry Letters 1994, DOI:10.1246/cl.1994.905 10.1246/cl.1994.905, 905-908.
(12) Appel, A. M.; Newell, R.; DuBois, D. L.; DuBois, M. R. Concentration of carbon dioxide by electrochemically modulated complexation with a binuclear copper complex. Inorg. Chem. 2005, 44, 3046-3056.
(13) Singh, P.; Rheinhardt, J. H.; Olson, J. Z.; Tarakeshwar, P.; Mujica, V.; Buttry, D. A. Electrochemical Capture and Release of Carbon Dioxide Using a Disulfide-Thiocarbonate Redox Cycle. Journal of the American Chemical Society 2017, 139, 1033-1036.
(14) Datta, S.; Henry, M. P.; Lin, Y. J.; Fracaro, A. T.; Millard, C. S.; Snyder, S. W.; Stiles, R. L.; Shah, J.; Yuan, J.; Wesoloski, L.; Dorner, R. W.; Carlson, W. M. Electrochemical CO2 Capture Using Resin-Wafer Electrodeionization. Industrial & Engineering Chemistry Research 2013, 52, 15177-15186.
(15) Mehmood, A.; Iqbal, M. I.; Lee, J.-Y.; Hwang, J.; Jung, K.-D.; Ha, H. Y. A novel high performance configuration of electrochemical cell to produce alkali for sequestration of carbon dioxide. Electrochimica Acta 2016, 219, 655-663.
(16) Rau, G. H. Electrochemical CO2 capture and storage with hydrogen generation. Energy Procedia 2009, 1, 823-828.
(17) Roy, R. N.; Roy, L. N.; Vogel, K. M.; Porter-Moore, C.; Pearson, T.; Good, C. E.; Millero, F. J.; Campbell, D. M. The dissociation constants of carbonic acid in seawater at salinities 5 to 45 and temperatures 0 to 45 C. Marine Chemistry 1993, 44, 249-267.
(18) Holmes, G.; Keith, D. W. An air-liquid contactor for large-scale capture of CO2 from air. Philos Trans A Math Phys Eng Sci 2012, 370, 4380-4403.
(19) Stolaroff, J. K.; Keith, D. W.; Lowry, G. V. Carbon Dioxide Capture from Atmospheric Air Using Sodium Hydroxide Spray. Environ Sci Technol 2008, 42, 2728-2735.
(20) Mahmoudkhani, M.; Keith, D. W. Low-energy sodium hydroxide recovery for CO2 capture from atmospheric air-Thermodynamic analysis. International Journal of Greenhouse Gas Control 2009, 3, 376-384.
(21) Keith, D. W.; Holmes, G.; St. Angelo, D.; Heidel, K. A Process for Capturing CO2 from the Atmosphere. Joule 2018, DOI:10.1016/j.joule.2018.05.006 10.1016/j.joule.2018.05.006.
(22) Henderson, M. A.; Keith, D. W.; Pal, A.; Kainth, S.; Heidel, R. K.; Ritchie, J. A. Target Gas Capture U.S. Patent 2014
(23) Dau, H.; Limberg, C.; Reier, T.; Risch, M.; Roggan, S.; Strasser, P. The mechanism of water oxidation: from electrolysis via homogeneous to biological catalysis. ChemCatChem 2010, 2, 724-761.
(24) Hong, W. T.; Risch, M.; Stoerzinger, K. A.; Grimaud, A.; Suntivich, J.; Shao-Horn, Y. Toward the rational design of non-precious transition metal oxides for oxygen electrocatalysis. Energy & Environmental Science 2015, 8, 1404-1427.
(25) May, K. J.; Carlton, C. E.; Stoerzinger, K. A.; Risch, M.; Suntivich, J.; Lee, Y.-L.; Grimaud, A.; Shao-Horn, Y. Influence of Oxygen Evolution during Water Oxidation on the Surface of Perovskite Oxide Catalysts. The Journal of Physical Chemistry Letters 2012, DOI:10.1021/jz301414z 10.1021/jz301414z, 3264-3270.
(26) Suntivich, J.; May, K. J.; Gasteiger, H. A.; Goodenough, J. B.; Shao-Horn, Y. “A Perovskite Oxide Optimized for Oxygen Evolution Catalysis from Molecular Orbital Principles,” 2011.
(27) Suntivich, J.; Gasteiger, H. A.; Yabuuchi, N.; Shao-Horn, Y. Electrocatalytic Measurement Methodology of Oxide Catalysts Using a Thin-Film Rotating Disk Electrode. Journal of the Electrochemical Society 2010, 157, B1263-B1268.
(28) Ng, J. W. D.; Tang, M.; Jaramillo, T. F. A carbon-free, precious-metal-free, high-performance 02 electrode for regenerative fuel cells and metal-air batteries. Energy & Environmental Science 2014, DOI:10.1039/c3ee44059a 10.1039/c3ee44059a.
(29) Viswanathan, V.; Hansen, H. A.; Rossmeisl, J.; Jaramillo, T. F.; Pitsch, H.; Nørskov, J. K. Simulating Linear Sweep Voltammetry from First-Principles: Application to Electrochemical Oxidation of Water on Pt (111) and Pt 3 Ni (111). The Journal of Physical Chemistry C 2012, DOI:10.1021/jp210802q 10.1021/jp210802q, 120210115310009.
(30) Man, I. C.; Su, H.-Y.; Calle-Vallejo, F.; Hansen, H. A.; Martínez, J. I.; Inoglu, N. G.; Kitchin, J.; Jaramillo, T. F.; Nørskov, J. K.; Rossmeisl, J. Universality in Oxygen Evolution Electrocatalysis on Oxide Surfaces. ChemCatChem 2011, 3, 1159-1165.
(31) Gorlin, Y.; Jaramillo, T. F. A bifunctional nonprecious metal catalyst for oxygen reduction and water oxidation. Journal of the American Chemical Society 2010, 132, 13612-13614.
(32) Costentin, C. Electrochemical Approach to the Mechanistic Study of Proton-Coupled Electron Transfer. Chem. Rev. 2008, 108, 2145-2179.
(33) Mayer, J. M. PROTON-COUPLED ELECTRON TRANSFER: A Reaction Chemist's View. 2004, 55, 363-390.
(34) Kwabi, D. G.; Lin, K.; Ji, Y.; Kerr, E. F.; Goulet, M.-A.; De Porcellinis, D.; Tabor, D. P.; Pollack, D. A.; Aspuru-Guzik, A.; Gordon, R. G.; Aziz, M. J. Alkaline quinone flow battery with long lifetime at pH 12. Joule 2018, 2, 1907.
(35) Ji, Y.; Goulet, M.-A.; Pollack, D. A.; Kwabi, D. G.; Jin, S.; De Porcellinis, D.; Kerr, E. F.; Gordon, R. G.; Aziz, M. J. A phosphonate-functionalized quinone redox flow battery at near-neutral pH with record capacity retention rate. Adv. Energy Mater. 2019.
(36) Wong, A. A.; Kwabi, D. G.; Aziz, M. J. Rational Evaluation and Cycle Life Improvement of Quinone-Based Aqueous Flow Batteries Guided by In-Line Optical Spectrophotometry. submitted 2018.
(37) Pour, N.; Kwabi, D. G.; Carney, T.; Darling, R. M.; Perry, M. L.; Shao-Horn, Y. Influence of Edge- and Basal-Plane Sites on the Vanadium Redox Kinetics for Flow Batteries. The Journal of Physical Chemistry C 2015, 119, 5311-5318.
(38) Jin, S. J.; Jing, Y.; Kwabi, D. G.; Ji, Y. L.; Tong, L. C.; De Porcellinis, D.; Goulet, M. A.; Pollack, D. A.; Gordon, R. G.; Aziz, M. J. A Water-Miscible Quinone Flow Battery with High Volumetric Capacity and Energy Density. Acs Energy Letters 2019, 4, 1342-1348.
(39) Bilger, D.; Park, K.-W.; Abdel-Maksoud, A.; Andrew, T. L. Broadband-absorbing polycyclic aromatic hydrocarbon composite films on topologically complex substrates. Organic Electronics 2020, 85, 105862.
(40) Bilger, D.; Park, K.-W.; Andrew, T. L. A vapor printed electron-accepting conjugated polymer for textile optoelectronics. Synthetic Metals 2019, 250, 1-6.
(41) Cheng, N.; Zhang, L.; Joon Kim, J.; Andrew, T. L. Vapor phase organic chemistry to deposit conjugated polymer films on arbitrary substrates. Journal of Materials Chemistry C 2017, 5, 5787-5796.
(42) Zhang, L.; Andrew, T. L. Deposition Dependent lon Transport in Doped Conjugated Polymer Films: Insights for Creating High-Performance Electrochemical Devices. Advanced Materials Interfaces 2017, 4, 1700873.
(43) Peng, Y.; Govindaraju, G. V.; Lee, D. K.; Choi, K.-S.; Andrew, T. L. Integrating a Semitransparent, Fullerene-Free Organic Solar Cell in Tandem with a BiVO4 Photoanode for Unassisted Solar Water Splitting. ACS Applied Materials & Interfaces 2017, 9, 22449-22455.
(44) Osedach, T. P.; Andrew, T. L.; Bulović, V. Effect of synthetic accessibility on the commercial viability of organic photovoltaics. Energy & Environmental Science 2013, 6, 711-718.
(45) Andrew, T. L.; Swager, T. M. Structure-Property relationships for exciton transfer in conjugated polymers. Journal of Polymer Science Part B: Polymer Physics 2011, 49, 476-498.
(46) Moslin, R. M.; Andrew, T. L.; Kooi, S. E.; Swager, T. M. Anionic Oxidative Polymerization: The Synthesis of Poly (phenylenedicyanovinylene) (PPCN2V). Journal of the American Chemical Society 2009, 131, 20-21.
(47) Jin, S.; Wu, M.; Gordon, R.; Aziz, M. J.; Kwabi, D. G. pH Swing Cycle for CO2 Capture Electrochemically Driven through Proton-Coupled Electron Transfer. In revision.
(48) Huang, C.; Liu, C.; Wu, K.; Yue, H.; Tang, S.; Lu, H.; Liang, B. CO2 Capture from Flue Gas Using an Electrochemically Reversible Hydroquinone/Quinone Solution. Energy & Fuels 2019, DOI:10.1021/acs.energyfuels.8b04419 10.1021/acs.energyfuels.8b04419.
(49) Xie, H.; Wu, Y.; Liu, T.; Wang, F.; Chen, B.; Liang, B. Low-energy-consumption electrochemical CO2 capture driven by biomimetic phenazine derivatives redox medium. Applied Energy 2019, DOI: https://doi.org/10.1016/j.apenergy.2019.114119 https://doi.org/10.1016/j.apenergy.2019.114119, 114119.
(50) Liu, Y.; Ye, H.-Z.; Diederichsen, K. M.; Van Voorhis, T.; Hatton, T. A.

Electrochemically mediated carbon dioxide separation with quinone chemistry in salt-concentrated aqueous media. Nature Communications 2020, 11, 2278.
(51) Stern, M. C.; Simeon, F.; Hammer, T.; Landes, H.; Herzog, H. J.; Hatton, T. A. Electrochemically mediated separation for carbon capture. Energy Procedia 2011, 4, 860-867.
(52) Stern, M. C.; Simeon, F.; Herzog, H.; Hatton, T. A.; Rochelle, G. T.; Littau, K. a.; Gelowitz, D.; Groom, D.; Wickham, C. Post-combustion carbon dioxide capture using electrochemically mediated amine regeneration. Energy & Environmental Science 2013, 6, 2505.
(53) Liu, Y. C.; McCreery, R. L. REACTIONS OF ORGANIC MONOLAYERS ON CARBON SURFACES OBSERVED WITH UNENHANCED RAMAN-SPECTROSCOPY. Journal of the American Chemical Society 1995, 117, 11254-11259.
(54) Bilger, D.; Homayounfar, S. Z.; Andrew, T. L. A critical review of reactive vapor deposition for conjugated polymer synthesis. Journal of Materials Chemistry C 2019, 7, 7159-7174.
(55) Andrew, T. L.; Zhang, L.; Cheng, N.; Baima, M.; Kim, J. J.; Allison, L.; Hoxie, S. Melding Vapor-Phase Organic Chemistry and Textile Manufacturing To Produce Wearable Electronics. Accounts of Chemical Research 2018, 51, 850-859.
(56) Allison, L.; Hoxie, S.; Andrew, T. L. Towards seamlessly-integrated textile electronics: methods to coat fabrics and fibers with conducting polymers for electronic applications. Chemical Communications 2017, 53, 7182-7193.
(57) Muench, S.; Wild, A.; Friebe, C.; Häupler, B.; Janoschka, T.; Schubert, U. S. Polymer-Based Organic Batteries. Chemical Reviews 2016, 116, 9438-9484.
(58) Viola, W.; Zhang, L.; Andrew, T. L. Oxidant aggregate-induced porosity in vapour-deposited polymer films and correlated impact on electrochemical properties. Supramol. Chem. 2019, 31, 491-498.
(59) Luo, J.; Sam, A.; Hu, B.; DeBruler, C.; Wei, X.; Wang, W.; Liu, T. L. Unraveling pH Dependent Cycling Stability of Ferricyanide/Ferrocyanide in Redox Flow Batteries. Nano Energy 2017, 42, 215-221.
(60) Luo, J., Hu, B., Debruler, C., Bi, Y., Zhao, Y., Bing, Y., Hu, M., Wu, W., Liu, T. L. Unprecedented capacity and stability of ammonium ferrocyanide catholyte in pH neutral aqueous redox flow batteries. Joule 2019, 3, 149-163.
(61) Hollas, A.; Wei, X.; Murugesan, V.; Nie, Z.; Li, B.; Reed, D.; Liu, J.; Sprenkle, V.; Wang, W. A biomimetic high-capacity phenazine-based anolyte for aqueous organic redox flow batteries. Nature Energy 2018, 3, 508-514.
(62) Winsberg, J.; Stolze, C.; Muench, S.; Liedl, F.; Hager, M. D.; Schubert, U. S. TEMPO/phenazine combi-molecule: a redox-active material for symmetric aqueous redox-flow batteries. ACS Energy Lett. 2016, 1, 976-980.
(63) Kwabi, D. G.; Ji, Y.; Aziz, M. J. Electrolyte Lifetime in Aqueous Organic Redox Flow Batteries: A Critical Review. Chemical Reviews 2020, DOI:10.1021/acs.chemrev.9b00599 10.1021/acs.chemrev.9b00599.
(64) Eisaman, M. D. Negative Emissions Technologies: The Tradeoffs of Air-Capture Economics. Joule 2020, 4, 516-520.
(65) “Negative Emissions Technologies and Reliable Sequestration,” 2019.

What is claimed:

1. A system for electrochemical direct air capture of CO₂, comprising
a CO₂ source from which CO₂ is to be captured;
a flow cell comprising a separator that divides the flow cell into a counter electrolyte chamber and a pH-varying electrolyte chamber, a counter electrode disposed in the counter electrolyte chamber, and a working electrode disposed in the pH-varying electrolyte chamber, the working electrode comprising a substrate having a coating comprising proton-coupled electron transfer molecules immobilized thereon, the substrate being a conductive substrate or comprising a conductive layer;
a pH-varying electrolyte tank in fluid communication with the flow cell and the CO₂ source;
a flash tank in fluid communication with the pH-varying electrolyte tank and optionally the flow cell;
a first flow path configured to allow a flow of the pH-varying electrolyte to circulate through the pH-varying electrolyte tank and the pH-varying electrolyte chamber of the flow cell, wherein during a charging cycle of the flow cell, flow through the first flow path results in an increase in pH of the pH-varying electrolyte caused by reduction of the proton-coupled electron transfer molecules and during a discharging cycle of the flow cell, flow through the first flow path results in a decrease in pH of the pH varying electrolyte by oxidation of the proton-coupled electron transfer molecules;
a second flow path configured to allow a flow of the pH-varying electrolyte to circulate through the pH-varying electrolyte tank and the CO₂ source, wherein the system is adapted to direct the pH-varying electrolyte through the second flow path after the pH of the pH-varying electrolyte is increased to thereby allow for sorption of CO₂ by the pH varying electrolyte from the CO₂ source during circulation through the second flow path; and
a third flow path configured to circulate a flow of the pH-varying electrolyte either:
through the pH-varying electrolyte tank and the release CO₂ reservoir, or
from the pH-varying electrolyte chamber to the flash tank and from the flash tank to the pH-varying electrolyte tank,
wherein the system is adapted to direct flow through the third flow path after the pH of the pH-varying electrolyte is reduced by the discharge cycle to thereby release the sorbed CO₂, and
wherein the counter electrode is a water-stable, charge-storing solid electrode or the system comprises a counter electrolyte tank in fluid communication with the flow cell and configured such that counter electrolyte is capable of being circulated through the counter electrolyte tank and the counter electrolyte chamber of the flow cell.

2. The system of claim 1, wherein the working electrode is a positive electrode.

3. The system of claim 1, wherein the working electrode is a negative electrode.

4. The system of any one of the preceding claims, further comprising an external power source for charging the flow cell.

5. The system of claim 4, wherein the external power source is a solar or wind power source.

6. The system of any one the preceding claims, wherein the proton-coupled electron transfer molecules are selected such that a pH swing of the pH-varying electrolyte during flow through the first flow path during charging and discharge is from about pH 14 to about pH 6.

7. The system of claim 6, wherein the pH swing is from about 13 to about 6.

8. The system of any one of the preceding claims, wherein the working electrode comprises a proton-coupled electron transfer polymer as the coating.

9. The system of any one of the preceding claims, wherein the substrate comprises a textile.

10. The system of claim 9, wherein the textile is one or more graphite felt, woven cotton fabric, tobacco cotton, cotton gauze, cotton muslin, wool felt, synthetic felt, nylon, and nylon/cotton blend.

11. The system of any one of the preceding claims, wherein the coating has a thickness of about 100 nm to about 10 microns.

12. The system of any one of the preceding claims, wherein the coating comprises or is formed of a monomer selected from one or more of sulfonated anthraquinone, hydroxyl-substituted sulfonated anthraquinone, 1-aminoanthraquinone, 2-aminoanthraquinone, Alizarin, Quinizarin, 1-pyrrolo-anthraquinone, 2-pyrrolo-anthraquinone, 2,3-diaminophenazine, carboxyl-substitute phenazine.

13. The system of any one of the preceding claims, wherein the working electrode comprises the conductive layer and the conductive layer comprises poly(3,4-ethylenedioxythiophene) (PEDOT).

14. The system of claim 13, wherein the conductive layer of PEDOT is interposed between the substrate and the coating comprising the proton-coupled electron transfer molecules.

15. The system of any one of the preceding claims, wherein the coating is arranged on opposed sides of the conductive layer or the conductive substrate.

16. The system of any one of the preceding claims, wherein the working electrode comprises an insulating substrate upon which the conductive layer is deposited.

17. The system of claim 16, wherein the conductive layer is disposed on opposed sides of the insulating substrate and the coating is disposed on the conductive layer on each of the opposed sides.

18. The system of claim 16 or 17, wherein the insulating substrate is a textile.

19. The system of any one of the preceding claims, wherein the pH-varying electrolyte further comprises a CO₂ hydration catalyst dissolved therein.

20. The system of claim 14, wherein the CO₂ hydration catalyst comprises one or more of carbonic anhydrase, zinc triazacycles, zinc tetraazacycles, copper glycinates, hydroxopentaaminecobalt perchlorate, formaldehyde hydrate, saccharose, phenols, phenolates, glycerin, arsenite, hypochlorite, hypobromite and oxyanionic species.

21. A process for the direct air capture of CO₂, comprising:
electrochemical de-acidification of a pH-varying electrolyte comprising performing a flow cell charging cycle comprising circulating the pH-varying electrolyte from a pH-varying electrolyte tank through a pH-varying electrolyte chamber of a flow cell, the pH-varying electrolyte chamber comprising a working electrode comprising a substrate having proton-coupled electron transfer molecules immobilized thereon, the substrate being a conductive substrate or comprising a conductive layer, the flow cell further comprising a counter electrode chamber having a counter electrode and a membrane separating the pH-varying chamber and the counter electrode chamber, wherein during circulation of the pH-varying electrolyte through the pH-varying electrolyte chamber, the proton-coupled electron transfer molecules are reduced thereby increasing of the pH-varying electrolyte to a CO₂ capture pH forming an alkaline pH-varying electrolyte;
a CO₂ capture step in which the alkaline pH-varying electrolyte is circulated in contact with a CO₂ source, wherein the alkaline pH-varying electrolyte sorbs CO₂ from the CO₂ source;
electrochemical acidification of the alkaline pH-varying electrolyte with sorbed CO₂ comprising a flow cell discharging cycle comprising circulating the alkaline pH-varying electrolyte with sorbed CO₂ through the pH-varying electrolyte chamber, wherein during discharge, the proton-coupled electron transfer molecules are oxidized thereby lowering the pH of the alkaline pH-varying electrolyte to a CO₂ release pH to form an acidified pH-varying electrolyte, the CO₂ release pH being less than the CO₂ capture pH; and
degassing the acidified pH-varying electrolyte to release the sorbed CO₂.

22. The process of claim 21, wherein CO₂ capture pH is alkaline.

23. The process of claim 22, wherein the CO₂ capture pH is up to 14

24. The process of claim 23, wherein the CO₂ capture pH is about 9 to about 13.

25. The process of any one of claims 21 to 24, wherein the CO₂ release pH is a neutral or substantially neutral pH.

26. The process of any one of claims 21 to 25, wherein the CO₂ release pH is about 4 to about 6.

27. The process of any one of claims 21 to 26, comprising applying a current density of 0.1 mA/cm² to about 20 mA/cm².

28. The process of any one of claims 21 to 27, wherein the pH-varying electrolyte is flowed at a flow rate of about 10 ml/min to about 100 ml/min.

29. The process of any one of claims 21 to 28, wherein the working electrode is a positive electrode.

30. The process of any one of claims 21 to 28, wherein the working electrode is a negative electrode.

31. The process of any one of claims 21 to 30, further comprising charging the flow cell by applying power from an external power source, the external power source being solar or wind power.

32. The process of any one of claims 21 to 31, wherein the working electrode comprises a proton-coupled electron transfer polymer as the coating.

33. The process of any one of claims 21 to 32, wherein the substrate comprises a textile.

34. The process of claim 33, wherein the textile is graphite felt.

35. The process of any one of claims 21 to 34, wherein the coating has a thickness of about 100 nm to about 10 microns.

36. The process of any one of claims 21 to 35, wherein the coating comprises or is formed of a monomer selected from one or more of sulfonated anthraquinone, hydroxyl-substituted sulfonated anthraquinone, 1-aminoanthraquinone, 2-aminoanthraquinone, Alizarin, Quinizarin, 1-pyrrolo-anthraquinone, 2-pyrrolo-anthraquinone, 2,3-diaminophenazine, carboxyl-substitute phenazine.

37. The process of any one of claims 21 to 36, wherein the working electrode comprises the conductive layer and the conductive layer comprises poly(3,4-ethylenedioxythiophene) (PEDOT).

38. The process of claim 37, wherein the conductive layer of PEDOT is interposed between the substrate and the coating comprising the proton-coupled electron transfer molecules.

39. The process of any one of claims 21 to 38, wherein the coating is arranged on opposed sides of the conductive layer or the conductive substrate.

40. The process of any one of claims 21 to 39, wherein the working electrode comprises an insulating substrate upon which the conductive layer is deposited.

41. The process of claim 40, wherein the conductive layer is disposed on opposed sides of the insulating substrate and the coating is disposed on the conductive layer on each of the opposed sides.

42. The process of claim 40 or 41, wherein the insulating substrate is a textile.

43. The process of any one of claims 21 to 42, wherein the pH-varying electrolyte further comprises a CO₂ hydration catalyst dissolved therein.

44. The process of claim 43, wherein the CO₂ hydration catalyst comprises one or more of carbonic anhydrase, zinc triazacycles, zinc tetraazacycles, copper glycinates, hydroxopentaaminecobalt perchlorate, formaldehyde hydrate, saccharose, phenols, phenolates, glycerin, arsenite, hypochlorite, hypobromite and oxyanionic species.
